(19) United States
(12) Patent Application Publication
(10) Pub. No.: US 2011/0305796 A1
(43) Pub. Date: Dec. 15, 2011

(54) Method and Equipment for Preparing Cheese or a Cheese Product

(76) Inventors: Florence Coulon, Paris (FR); Beudon Didier, Rambouillet (FR); Russo Paul, Untrasried Allernagne (DE)

(21) Appl. No.: 13/120,072

(22) PCT Filed: Sep. 8, 2009
(86) PCT No.: PCT/FR2009/001070

§ 371 Date: Jun. 6, 2011

(30) Foreign Application Priority Data
Sep. 24, 2008 (FR) 08 05246

(51) Int. Cl. A23C 19/06; A01J 25/00

(52) U.S. Cl. 426/36; 426/582; 99/453; 99/450.1

(57) ABSTRACT

The present invention relates to a method and to equipment for preparing cheese or a cheese product containing at least one heat-sensitive compound having a positive nutritional effect such as a probiotic bacterium. The preparation method of the invention comprises: hot mixing a cheese paste and at least one compound having a positive nutritional effect, such as a probiotic bacterium, a seric protein, a vitamin or a micronutrient; and hot-metering the mixture thus obtained into a container (10) that is the subsequent packaging of the cheese or cheese product. According to the invention, the mixing is carried out immediately before the metering for a duration lower than 10 seconds and at a temperature higher than or equal to 60° C. in order to achieve a minimized thermal spoilage rate of the compound or each compound in said container for the entire product shelf life.

The present invention relates to a method and to equipment for preparing cheese or a cheese product incorporating at least one heat-sensitive compound having a positive nutritional effect, such as a probiotic bacterium. The invention applies to the metering of such cheeses or cheese products, in particular a processed cheese or a fresh paste prepared according to a “hot” technology.

In a known manner, the production of processed cheeses uses a precise metering system for filling a container which may be of aluminum or plastic portion, plastic tub or plastic casing type. The amounts of grams encountered industrially are commonly about from 18 g-20 g per portion, from 80 g to 150 g for tubs and several hundred grams, or even several kilos, for casings.

The industrial metering of a processed cheese is carried out hot, typically at a temperature of at least 70 to 72° C., in order to allow filling and hygienic sealing of the container. Given that the upstream process of melting this cheese can be carried out at from 80° C. (pasteurization) to 140° C. (sterilization on a UHT line), it is considered, in practice, that vegetative forms of bacteria are completely destroyed by the melting and metering process. Specifically, this process in fact corresponds to a long period of hold in a secondary hopper at a destructive temperature above 70° C., which significantly contributes to this destruction.

Thus, it appears to be very difficult to incorporate live bacteria having a positive nutritional effect (i.e. probiotic bacteria) into processed cheeses, owing to the fact that the thermal destruction curves of the corresponding strains, which are not very heat-resistant, show a virtually complete destruction of the probiotic flora by the heat, even in the case where a very high initial amount of bacteria, of about 10⁹ to 10¹⁰ cfu/g, is added to the processed paste. The thermal destruction rate of these bacteria, expressed by log Nt/N0, N0 being the initial bacterial load in the mixture and Nt that at storage time t after metering, can thus reach the maximum level of −9 or −10.

It has nevertheless been sought in the past to produce processed cheese incorporating such live bacteria, such as lactic acid bacteria, by considerably cooling the processed paste before mixing these bacteria into it, as described in document WO-A-2007/072901, in which the temperature is reduced to 35° C. with a view to this mixing and the subsequent metering.

The low-temperature metering method presented in this document is, at a pinch, acceptable in the case of a logistic circuit with a cold chain maintaining a temperature between 4 and 8° C., as in most countries of Western Europe, with nevertheless a shelf life of the metered product which is then reduced to 45 days instead of the usual minimum 60 to 90 days. However, a major drawback of this method is that the temperature of 35° C. used for the metering is not at all suitable for certain countries where the logistic circuit and the cold chain do not have this degree of reliability, for example owing to much higher ambient temperatures.

One objective of the present invention is to provide a method for preparing cheese or a cheese product, in particular a processed cheese, which remedies the abovementioned drawbacks resulting in particular from the operating temperatures selected, this method comprising essentially:
hot-mixing a cheese paste and at least one heat-sensitive compound having a positive nutritional effect, such as a probiotic bacterium, a serum protein, a vitamin or a micronutrient, and
hot-metering the resulting mixture into a container which is suitable for being the subsequent packing of the cheese product.

To this effect, the method according to the invention is such that this mixing is carried out immediately before this metering, for a period of less than 10 seconds and at a temperature higher than or equal to 60° C., in order to obtain a minimized thermal destruction rate of the or each compound in this container for the entire shelf life of the cheese or of the cheese product.

Preferably, this mixing is carried out at a temperature higher than or equal to 68° C., and even more preferably of between 70° C. and 72° C.

In the case where this mixing is carried out with probiotic bacteria and at a temperature of between 60° C. and 65° C. approximately, class 100 or 10 (i.e. purified) clean air is advantageously also blown just above the container receiving the metered mixture, preferably using blowing means as described in one or other of documents EP-B1-0 895 570, EP-B1-0 966 638 and EP-B1-1 147 345.

As regards the period of time for which said or each compound is brought into contact with this cheese paste, it is preferably between 1 and 5 seconds.

It will be noted that the very brief period for which the compound(s) is (are) brought into contact with the cheese paste combined with this sufficiently high mixing temperature makes it possible to obtain, after metering, a log Nt/N0 destruction rate of about −4 to −5, advantageously using for this compound or at least one of these compounds a lactic acid bacterium chosen from the group consisting of strains of Lactobacillus acidophilus, Lactobacillus rhamnosus and Pediococcus acidilactici (several strains of lactic acid bacteria can be used in combination in the method of the invention).

It will also be noted that this mixing immediately preceding the metering in the invention (i.e. with mixing substantially concomitant with the metering) makes it possible to retain, on the one hand, the usual heat conditions for hot-metering so as to meet the hygiene requirements for the portions metered and, on the other hand, the presence, in these portions, of these heat-sensitive compounds (e.g. live strains or other ingredients having a positive effect) with minimization of their thermal destruction.

According to another feature of the invention, this mixing is carried out at the inlet of a metering head delivering said mixture directly into this container.

Advantageously, prior to this mixing, said compound(s) can be hot-injected into the mass of this cheese paste which is then at a temperature higher than or equal to 60° C., preferably by means of a metering pump with piston and spool, it being possible for the particles consisting of said injected compound(s) to be dissolved or dispersed in a liquid cream which is kept stirring.

According to one particularly advantageous embodiment of the invention, prior to this injection, said particles are microencapsulated with a homogeneous hydrophobic coating layer, which comprises at least one hydrophobic substance chosen from a fatty acid, a wax and a mixture thereof and which is formed by injection of this molten hydrophobic substance into a chamber containing these particles which are stirred by rotation of the bottom of the chamber and swept with a stream of air. This microencapsulation can be carried out according to the procedure described in document WO-A-01/68808.

It will be noted that this microencapsulation of the particles of compound(s) to be incorporated into the cheese paste, which is carried out prior to this incorporation, protects these particles against external attacks such as those by gastric juices and, moderately, temperature and as a result makes it possible to obtain even lower thermal destruction rates, that can advantageously reach values of −1 to −3, thereby making the method of the invention particularly advantageous for industry.

According to one exemplary embodiment of the invention relating in particular to the case where the compound(s) to be incorporated is (are each) a probiotic bacterium of the lactic acid bacteria family, the concentration of this compound or these compounds in said cream can be between 10⁹ and 10¹⁰ cfu/g, and the concentration of the compound(s) in the mixture can then advantageously be between 5×10⁸ and 5×10⁹ cfu/g.

According to another feature of the invention, said mixing can advantageously be carried out in a countercurrent manner or by radial flow, so as to optimize the distribution of said or of each compound in the cheese paste mass and to generate a sufficient pressure drop to minimize drainage of the mixture.

Preferably, said mixing is carried out in a static micromixer, preferably a multi-element static micromixer.

It will be noted that this micromixer has the advantage of optimizing the distribution of the compound(s) in the cheese paste, but that it would nevertheless be possible to do without a micromixer without departing from the context of the present invention.

Cheese or a cheese product obtained by means of the method of preparation as defined above, in which said compound(s) is (are each) a probiotic bacterium which belongs to the lactic acid bacteria family, is characterized in that it contains, immediately after this metering, this lactic acid bacterium or these lactic acid bacteria in the live state according to a total concentration of greater than or equal to 10⁶ cfu/g.

Advantageously, this cheese or this cheese product according to the invention can contain, four months after this metering, this lactic acid bacterium or these lactic acid bacteria in the live state, according to a concentration of greater than or equal to 10⁴ cfu/g and advantageously greater than 10⁵ cfu/g.

It is thus possible to validly claim a sufficient concentration of probiotic bacteria or “live ferments” in the portions obtained and thus a proven nutritional effect, owing to the fact that there are 10⁵ to 10⁶ residual cfu/g at the end of the “BBD” (best before date), i.e. after a minimum of 90 to 120 days of storage at 4-8° C. or at 20-22° C. (ambient temperature).

As indicated above, it should be recalled that the compound(s) which can be used in the present invention can be any heat-sensitive compounds having a positive nutritional effect, for instance vitamins and/or various micronutrients, and that the cheeses or cheese products hot-metered in the method of the invention can comprise cheeses other than processed cheeses, e.g. fromage frais.

An equipment according to the invention is suitable for carrying out the method for preparing cheese or a cheese product as defined above, and this equipment is characterized in that it comprises:
a hopper for metering cheese paste at a temperature higher than or equal to 60° C., which has a metering body which opens into a pipe for feeding the paste in the direction of a cheese or cheese product metering head, arranged downstream of the equipment,
a reservoir for metering said compound(s), which has for example a metering pump with piston and spool, extending via a microcannula for injecting this or these compound(s) into this feed pipe,
a static micromixer, preferably a multi-element static micromixer, which is arranged downstream of this pipe and at the inlet of this metering head, and
a food container, such as a tub, into which said metering head opens and which is suitable for receiving a mass of the cheese or of the cheese product of preferably between 10 g and 30 g.

Optionally, this equipment according to the invention also advantageously comprises the abovementioned means for blowing class 100 or 10 clean air just above the container or else at the level of the metering head, in connection with the injection of probiotic bacteria and in the case of a mixing temperature of between 60° C. and 65° C. approximately.

According to another feature of the invention, this equipment can also comprise a unit for microencapsulation of particles of this compound or these compounds with a homogeneous hydrophobic coating layer, this unit comprising a chamber into which at least one molten hydrophobic substance is intended to be injected and which is intended to contain these particles stirred by rotation of the bottom of the chamber and swept with a stream of air.

Other features, advantages and details of the present invention will emerge on reading the following description of several exemplary embodiments of the invention, given by way of nonlimiting illustration, said description being given with reference to the attached drawings, among which:

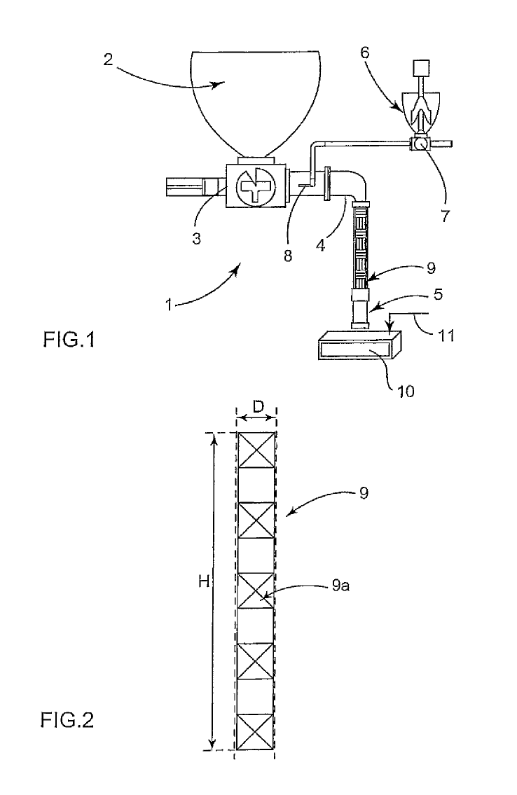

FIG. 1 is a partial diagrammatic elevation and axial section view of equipment according to the invention for preparing cheeses or cheese products incorporating compounds having a positive nutritional effect,

FIG. 2 is a diagrammatic axial section view of a static micromixer that can be used in the equipment of FIG. 1,

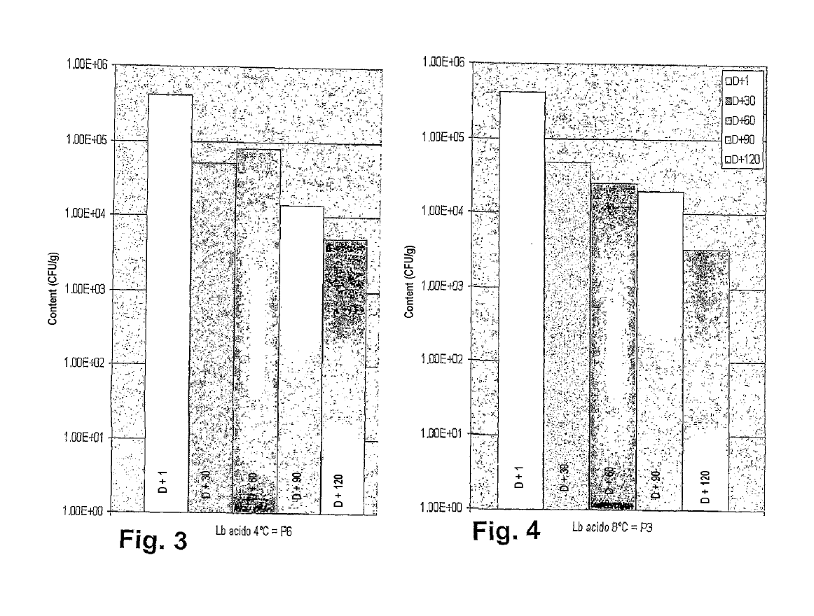

FIG. 3 is a bar graph showing the monthly change in the amount of probiotic compound measured in portions of processed cheese according to the invention, obtained by means of the equipment of FIG. 1, at a storage temperature for these portions equal to 4° C.,

FIG. 4 is a bar graph showing the monthly change in the amount of the same probiotic compound measured in these same portions according to the invention, at a storage temperature of 8° C.,

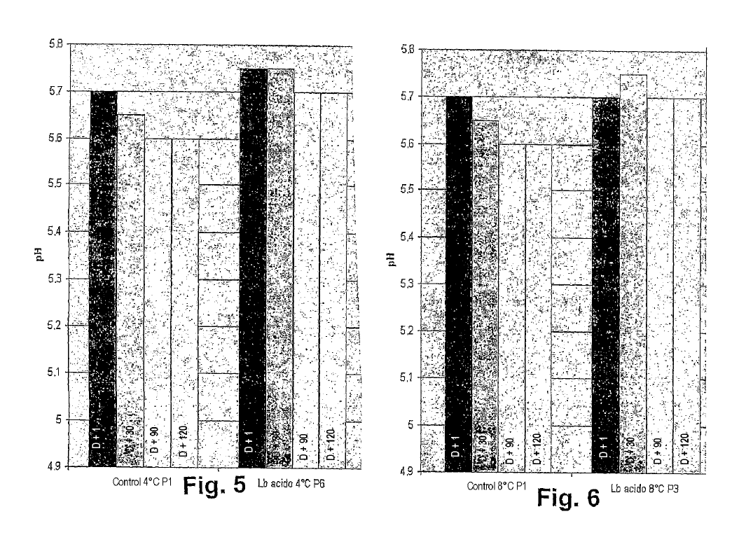

FIG. 5 is a bar graph showing the monthly change in the pH of portions of cheese according to the invention in comparison with “control” cheese portions devoid of probiotic compound, at the same storage temperature for these portions, equal to 4° C., and

FIG. 6 is a bar graph showing the monthly change in the pH of these portions of cheese according to the invention in comparison with these “control” cheese portions, at the same storage temperature for these portions, equal to 8° C.

As illustrated in FIG. 1, equipment 1 according to the invention essentially comprises:

a jacketed metering hopper 2 (for example of the name Comas) intended to receive a processed cheese paste from a cooker (not illustrated) at a temperature higher than or equal to 60° C., this hopper 2 having a metering body 3 with piston and spool which opens into a pipe 4 for feeding the processed paste in the direction of a head 5 for metering the cheese product, arranged downstream,

a metering reservoir 6 (for example sold by PCM Food under the name Dosys DACC 8/20-8) intended for metering compounds having a positive nutritional effect, such as probiotic bacteria, which has a micro-metering pump 7, for example a micro-metering pump with piston and spool, extending via a microcannula 8 for injecting this compound or these compounds into the feed pipe 4,

a multi-element static micromixer 9 (for example sold by SULZER CHEMTECH France under the name SMXS DN10) which is arranged downstream of this pipe 4 and at the inlet of the metering head 5,

a food tub 10, for example made of plastic, into which the metering head 5 opens and which is intended for receiving a mass of processed cheese of, for example, between 10 g and 30 g and, optionally,

means 11 for blowing class 100 or 10 clean air, arranged just above the container 10 or else at the level of the metering head 5, in order to purify the air in the direction of this container 10.

More specifically, the metering hopper 2 is capable of containing the processed cheese at a temperature of at least 74° C., with a metered mass that can range from a few grams to several kilograms.

The metering reservoir 6 is capable of metering a solution of a probiotic bacterium or probiotic bacteria according to a mass of, for example, a few tenths of a gram. This reservoir 6 is in particular intended to contain a suspension of live probiotic bacteria at 20-22° C. and it is equipped with a temperature probe upstream of the micro-metering pump 7, which has, for example, the following characteristics:
piston diameter: 8 mm
piston travel: 20 mm
full bore: 8 mm
discharge pressure: 13 bar
adjustable displacement (10-100%): 0.01 to 1 cm³
suction/discharge connections: ¾ gas

The injection of this bacterial suspension is preferably carried out in the pipe 4 at a temperature of approximately 70-72° C.

As regards the static micromixer 9 which is illustrated in FIG. 2, it comprises a plurality of elements 9a of the SMXS model which are successively offset by 90°. The internal diameter D of this micromixer 9 is, for example, 10.75 mm, for a height H of 90.9 mm.

### Example of Preparation According to the Invention of a Processed Cheese Incorporating Probiotic Bacteria

The processed cheese used was produced mainly from lactic fatty curds, butter, milk powder, casein powder and melting salts, in a Stephan UMM/SK 24E cooker (supplier: Stephan France). The starting materials were mixed and heat-treated up to a minimum temperature of 85° C. and kept at temperature for a few minutes to several tens of minutes.

Physicochemical characteristics of this processed cheese:
dry extract (DE)=47.5%
fat=32%
pH=5.4.

This processed cheese was transferred into the metering hopper 2 which was kept at a temperature higher than 76° C. by means of a jacketed shell.

In parallel, probiotic bacteria of the Lactobacillus acidophilus Rosell-52 ME strain were prepared in this exemplary embodiment, said bacteria being provided by the Institut Rosell Lallemand. These bacteria were mixed with a solution of light UHT liquid cream (15% fat) while keeping them stirring throughout the metering.

The concentration Nc of these probiotic bacteria in the cream was 5×10⁹ cfu/g.

An amount of 0.4 g of this bacterial suspension, that was microencapsulated beforehand according to the technique given in document WO-A-01/68808, was incorporated into a dose of processed cheese of approximately 20 g. This incorporation of the bacteria into the processed cheese was carried out at a temperature of approximately 70° C. with a contact time of approximately two seconds, and the amount of the bacteria incorporated into the processed cheese was therefore approximately N0=1×10⁸ cfu/g.

On D+1, the count for these bacteria in the processed cheese portion was N_{D+1}=1×10⁶ cfu/g. The thermal destruction rate was therefore log (N_{D+1}/N0)=−2, which is satisfactory.

As illustrated in FIGS. 3 and 4, a study of storage for 4 months in a cold room at 4° C. (FIG. 3) and at 8° C. (FIG. 4) of the resulting cheese portions made it possible to determine the concentration or survival rate of these Lactobacillus acidophilus bacteria.

After 4 months of storage, the concentration in the portion is approximately N_{D+120}=1×10⁴ cfu/g. The destruction rate during storage is therefore log (N_{D+120}/N_{D+1})=−2.

As illustrated in FIGS. 5 and 6, a study to monitor the intrinsic characteristics (texture/flavors) of the cheese portions obtained with or without Lactobacillus acidophilus bacteria (i.e. for portions according to the invention and for these “control” portions) was also carried out using a panel of experts. This monitoring was carried out every month throughout the storage of the products, at 4° C. for FIG. 5 and at 8° C. for FIG. 6.

This panel evaluated by comparison the texture and the flavor of the cheese portions according to the invention and the “control” cheese portions, reaching the conclusion that no difference in texture or in flavors can be found between these two types of portions analyzed throughout the entire period of monitoring over 6 months.

In summary, it should be noted that the hot-metered cheese portions (metered at a temperature higher than or equal to 60° C.) incorporating probiotic bacteria—preferably microencapsulated probiotic bacteria—still contain these live bacteria in sufficient amount to produce a proven nutritional effect, while at the same time exhibiting enduring properties during their storage which are free of any particular faults.

1. A method for preparing cheese or a cheese product, in particular processed cheese, comprising essentially:
hot-mixing a cheese paste and at least one heat-sensitive compound having a positive nutritional effect, such as a probiotic bacterium, a serum protein, a vitamin or a micronutrient, and
hot-metering the resulting mixture into a container that is suitable for being the subsequent packaging of the cheese or cheese product,
characterized in that this mixing is carried out immediately before this metering, for a period of less than 10 seconds and at a temperature higher than or equal to 60° C., in order to obtain a minimized thermal destruction rate of the or each compound in this container for the entire shelf life of the cheese or of the cheese product.

2. The method as claimed in claim 1, characterized in that this mixing is carried out at a temperature higher than or equal to 68° C.

3. The method as claimed in claim 1, characterized in that this mixing is carried out at the inlet of a metering head delivering said mixture directly into this container.

4. The method as claimed in claim 1, characterized in that the period of time for which said or each compound is brought into contact with this cheese paste is between 1 and 5 seconds.

5. The method as claimed in claim 1, characterized in that, prior to this mixing, said compound(s) is (are) hot-injected into the mass of this cheese paste which is then at a temperature higher than or equal to 60° C., the particles consisting of said injected compound(s) being dissolved or dispersed in a liquid cream which is kept stirring.

6. The method as claimed in claim 5, characterized in that, prior to this injection, said particles are microencapsulated with a homogeneous hydrophobic coating layer, which comprises at least one hydrophobic substance chosen from a fatty acid, a wax and a mixture thereof and which is formed by injection of this molten hydrophobic substance into a chamber containing these particles stirred by rotation of the bottom of the chamber and swept with a stream of air.

7. The method as claimed in claim 5, characterized in that said compound(s) is (are each) a probiotic bacterium which belongs to the lactic acid bacteria family, the concentration of the compound(s) in said cream being between 10⁹ and 10¹⁰ cfu/g.

8. The method as claimed in claim 7, characterized in that the concentration of said compound(s) in the mixture is between 5×10⁸ and 5×10⁹ cfu/g.

9. The method as claimed in claim 7, characterized in that said or at least one of said compound(s) is a lactic acid bacterium chosen from the group consisting of Lactobacillus acidophilus, Lactobacillus rhamnosus and Pediococcus acidilactici.

10. The method as claimed in claim 1, characterized in that said mixing is carried out in a countercurrent manner or by radial flow, so as to optimize the distribution of said or each compound in the cheese paste mass and to generate a pressure drop sufficient to minimize drainage of the mixture.

11. The method as claimed in claim 10, characterized in that said mixing is carried out in a static micromixer.

12. Equipment for carrying out a method as claimed in claim 1, characterized in that it comprises:
a hopper for metering cheese paste at a temperature higher than or equal to 60° C., which has a metering body which opens into a pipe for feeding the cheese paste in the direction of a head for metering the cheese or the cheese product, arranged downstream of the equipment,
a reservoir for metering said compound(s) which has a metering pump with a piston and spool, extending via a microcannula for injecting this or these compound(s) into this feed pipe,
a multi-element static micromixer which is arranged downstream of this pipe and at the inlet of this metering head, and
a food container into which said metering head opens and which is suitable for receiving a mass of the cheese or of the cheese product of between 10 g and 30 g.

13. The equipment as claimed in claim 12, characterized in that it also comprises a unit for microencapsulation of particles of this compound or these compounds with a homogeneous hydrophobic coating layer, this unit comprising a chamber into which at least one molten hydrophobic substance is intended to be injected and which is intended to contain these particles stirred by rotation of the bottom of the chamber and swept with a stream of air.

14. The method as claimed in claim 5, characterized in that said compound(s) is (are) hot-injected into the mass of this cheese paste by means of a metering pump with piston and spool.
